(19) United States
(12) Patent Application Publication
(10) Pub. No.: US 2025/0235851 A1
(43) Pub. Date: Jul. 24, 2025

(54) Microwave-Accelerated Aqueous Solvent Regeneration using Microwave Absorbers for Carbon Capture

(71) Applicant: United States Department of Energy, Washington, DC (US)

(72) Inventors: Fan Shi, Pittsburgh, PA (US); McMahan Gray, Pittsburgh, PA (US); Yee Soong, Canonsburg, PA (US); Yuhua Duan, Canonsburg, PA (US); Tuo Ji, Parma, OH (US)

(21) Appl. No.: 18/420,481

(22) Filed: Jan. 23, 2024

(51) Int. Cl. B01J 20/34; B01D 53/14; B01J 20/22

(52) U.S. Cl. CPC B01J 20/3441; B01D 53/1425; B01D 53/1475; B01D 53/1493; B01J 20/22; B01D 2252/204; B01D 2252/60; B01D 2257/504; B01D 2259/40094; B01D 2259/806

(57) ABSTRACT

A method of regenerating spent aqueous solvent using microwave absorbers featuring: adding a microwave absorber to a spent CO₂ solvent solution, forming a mixture of microwave absorber material dispersed in the spent CO₂ solvent solution, wherein the spent CO₂ solvent solution is an aqueous solution of spent CO₂ sorbent, wherein spent CO₂ sorbent is a CO₂ sorbent with CO₂ absorbed thereon; and exposing the mixture to microwaves, resulting in desorption of absorbed CO₂ from the CO₂ sorbent, regenerating CO₂ sorbent. A system for regenerating spent aqueous solvent having: a mixture having: an aqueous solution of a spent CO₂ sorbent, wherein the spent CO₂ sorbent is a CO₂ sorbent with CO₂ absorbed thereon; and a microwave absorber material mixed in the aqueous solution of spent CO₂ sorbent, wherein the microwave absorber material is an electrical insulator that is configured to be polarized by an applied electric field.

### STATEMENT OF GOVERNMENT SUPPORT

The United States Government has rights in this invention pursuant to the employer-employee relationship of the Government to the inventors as U.S. Department of Energy employees and site-support contractors at the National Energy Technology Laboratory.

### FIELD OF THE INVENTION

Embodiments relate to methods for regenerating liquid carbon dioxide solvents using microwave absorbers for carbon capture. More specifically, embodiments relate to methods of regenerating aqueous solvents featuring microwave absorbers in microwave environments, with said microwave absorbers providing improved CO₂ desorption kinetics, improved solvent regeneration efficiency, and a lower solvent regeneration temperature than those of conventional solvent regeneration methods.

### BACKGROUND

Greenhouse gas emissions, widely recognized as the main contributor for anthropogenic climate change, have elevated the concentration of carbon dioxide (CO₂) in the atmosphere by 46% from approximately 277 ppm in 1750 to 413 ppm in 2020. Post-combustion CO₂ capture, or carbon sequestration, is widely considered as one of the most effective near-term mitigation strategies for combating CO₂ emissions from large point sources. Carbon sequestration is a two-step process where the capture of carbon dioxide from a gas stream is followed by permanent storage.

Of particular interest are power generation point sources that burn fossil fuels. Since nearly one-third of the anthropogenic CO₂ emissions are produced by these facilities, conventional coal-burning power plants and advanced power generation plants-such as integrated gasification combined cycle-present opportunities where carbon can be removed and then permanently stored. At the current time, pulverized coal-fired-base steam cycles have been the predominant electric power generation technology, and this technology will continue to be used predominantly in the future. Technologies for capturing CO₂ from flue gas streams will need to be applied to new more efficient coal-fired facilities and will need to be retrofitted onto existing plants.

Today, aqueous amine scrubbing is the most mature technology for post-combustion CO₂ capture. Traditionally, this wet scrubbing process removes CO₂ in an amine-based solvent, then regenerates the spent scrubbing solvent in a vessel by indirectly heating the solution with steam. Monoethanolamine (MEA) aqueous solution (or mixed with small amount of Diethyleneamine (DEA) and Triethyleneamine (TEA)) is the industry benchmark amine solvent, which can react with CO₂ to form a stable and soluble carbamate salt, as shown in following reaction:

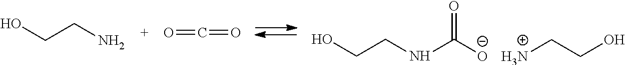

Upon heating, the MEA carbamate (heretofore isolated from the CO₂ feed stream) breaks down to free CO₂ via scission of C—N bonds, resulting in the original amine being regenerated to react with additional CO₂, wherein this scission is referred to as desorption of the CO₂. The process operates on a temperature swing, wherein CO₂ absorption by the amines occurs at low temperatures of approximately 50° C., and CO₂ desorption from the amines occurs at higher temperatures of greater than approximately 110° C. For the MEA process, changing the temperature results in a change in the chemical equilibrium between the amines and CO₂, wherein the affinity between the amines and CO₂ is much lower at higher temperatures than at lower temperatures.

While there have been large scale commercial demonstrations of this aqueous amine-based scrubbing process, it has several disadvantages, including a high heat of reaction, low working capacity, corrosiveness of the solution to desorption and regeneration infrastructure, amine degradation, and notably, its need to be in a liquid aqueous solution. Indeed, solvent regeneration is the most energy- and cost-intensive operation, as it often requires a large amount of superheated steam to raise the bulk temperature of the solvent to above 120° C. for reactive regeneration to occur. Further, the time needed to thermally swing an aqueous amine solution over such a temperature range can be several hours, and this time-consuming steam regeneration process may cause incomplete regeneration and low working capacities from inefficient CO₂ desorption.

Unsurprisingly, this conventional process results in a large energy need to regenerate the spent amine solvent solution, especially for the sensible heating of the water, which is a minimum of 70 wt % of the solution used in conventional processes. Likewise, the evaporative heat loss from vaporizing liquid water results in a need for significant make-up water input for each regeneration cycle. Consequently, aqueous amine-based carbon capture deployment could nearly double water consumption at fossil fuel-fired power plants, which would impose a significant environmental burden to the plant operation. Additionally, aqueous amines under superheated steam conditions can suffer from degradation and the high temperatures reached in the presence of amines can promote corrosion of infrastructure. These issues combined, and the need for large infrastructure and heat exchangers to address said issues, can contribute up to 70% of overall operating costs. At bottom, such aqueous capture processes are inherently accompanied with large capital and operating costs, as well as large parasitic loads and water use.

Recently, microwave energy has been used to heat solvents as a promising alternative to steam heating. For polar solvents, such as MEA solution, microwave heating primarily takes place via reorientation of molecular dipoles in the presence of the rapidly oscillating electric field. Dipole rotation causes these molecules to collide with others thereby transferring energy to adjacent molecules and consequently raising the temperature of the bulk solvent. Microwave heating offers advantages over steam heating, including instantaneous and volumetric heating without the heat transfer restrictions associated with conventional conductive or convective heating. Consequently, microwave-accelerated heating of solvents has been reported to improve the efficiency of the solvent regeneration process, including through increased product yield, shorter solvent regeneration time, and reduced energy cost of CO₂ desorption when compared to conventional heating techniques using steam. Likewise, microwave-assisted CO₂ desorption from solid sorbents has been recently reported for silica, zeolites, activated carbon, and polymeric absorbents, with fast desorption kinetics and low energy consumption.

Embodiments of the invention described herein further improve the efficiency of microwave-accelerated processes for regenerating aqueous amine solvents by adding microwave absorbers to the solvent solution. Microwave absorbers are dielectric and magnetic materials that can dissipate electromagnetic waves in a range of approximately 300 MHz-300 GHz by converting them into thermal energy through dielectric loss and magnetic loss. Dielectric loss is characterized as the electrical interaction between an electric field of incident electromagnetic radiation and the microwave absorber. Magnetic loss is characterized as the magnetic interaction between an electromagnetic wave and the microwave absorber. Generally, there are two categories of microwave absorbers: (i) microwave absorbers that exhibit enhanced magnetic losses due to resonance phenomena in higher electromagnetic frequency regions (>300 MHZ), which includes ferrite-based materials, carbonyl iron, nickel, and cobalt; and (ii) microwave absorbers that exhibit permittivity to increase dielectric losses, which includes carbon-based materials, active carbon, and carbon nanotube/MoS₂.

An embodiment of the invention described herein utilizes graphene particles as a microwave absorber material within the solvent solution. In an embodiment, graphene is inexpensively produced from the conversion of domestic coal, including raw coals from anthracite, bituminous, and lignite coal, as well as coal-derived carbonous feeds, i.e., coal refuse and beneficiated coal.

Graphene is a 2-dimensional nano-sheet material of carbon atoms arranged in a hexagonal network. Notably, graphene lacks a porous micro-structure typically required to host gas molecules. Therefore, in contrast to other porous carbon materials, graphene does not affect the adsorption and desorption kinetics of CO₂ after mixing with amine solution. Further, graphene can exhibit outstanding surface areas (2630 m² g⁻¹), high Young's modulus (1 TPa), high thermal conductivity (5000 W mK⁻¹), strong chemical durability and high electron mobility (2.5×10⁵ cm²V⁻¹ s⁻¹). Additionally, while graphene's electric permittivity varies with frequency over a range from microwave to millimeter wave frequencies, graphene has roughly an electric permittivity of 3.3, which means it is able to store large amounts of electrical energy. These properties make graphene ideal for imparting mechanical strength, corrosion resistance, and thermal and electrical conductivity to composite materials, making it an effective microwave absorber material.

In an embodiment of the invention described herein, the addition of graphene to aqueous MEA solution followed by microwave heating demonstrated improved CO₂ desorption kinetics and MEA regeneration efficiency, as well as lower solvent regeneration temperature compared to those of both steam heating and microwave heating without graphene. Indeed, in an embodiment, the microwave desorption rate of MEA solution with graphene is over two orders of magnitude faster than thermal heating. Likewise, as CO₂ desorption is recognized as a pseudo-first order reaction, in an embodiment, the apparent activation energy of desorption of MEA solution with graphene regenerated under microwave heating is about 25.6 KJ·mol⁻¹ (typically between about 20 KJ·mol⁻¹ and about 28 KJ·mol⁻¹), which is lower than reported activation energy values of about 35-60 KJ·mol⁻¹ where the aqueous amine solution was regenerated using conventional steam heating.

A need exists in the art for a more energy efficient and cost-effective method of regenerating spent liquid aqueous amine solvents that overcomes the disadvantages of the prior art. The novel method and principles of operation are further discussed in the following description.

### SUMMARY

Embodiments of the invention provide methods to regenerate spent aqueous solvent using microwave absorbers for carbon dioxide capture applications. Traditionally, solvent regeneration using conventional thermal heating is an energy- and cost-intensive operation for post-combustion CO₂ capture, as it often requires a large amount of superheated steam to raise the bulk temperature of the solvent to above 120° C. for reactive regeneration to occur. Recently, microwave energy has been used to heat solvents as a promising alternative to steam heating. One object of the invention is to improve the efficiency of microwave-accelerated processes for regenerating aqueous amine solvents by adding microwave absorbers to the solvent solution. An embodiment of the invention described herein utilizes graphene particles as a microwave absorber material within the solvent solution. In an embodiment, the addition of graphene to aqueous MEA solution followed by microwave heating demonstrated improved CO₂ desorption kinetics and MEA regeneration efficiency, as well as lower solvent regeneration temperature compared to those of both steam heating and microwave heating without graphene. In an embodiment, the apparent activation energy of desorption of MEA solution with graphene regenerated under microwave heating is lower than reported activation energy values where the aqueous amine solution was regenerated using conventional steam heating.

The invention provides a method of regenerating spent aqueous solvent using microwave absorbers for carbon dioxide capture applications comprising the steps of: adding a microwave absorber material to a spent CO₂ solvent solution, forming a mixture comprising the microwave absorber material dispersed in the spent CO₂ solvent solution, wherein the spent CO₂ solvent solution comprises an aqueous solution of spent CO₂ sorbent, wherein spent CO₂ sorbent comprises a CO₂ sorbent with CO₂ absorbed thereon; and exposing the mixture to microwave radiation, resulting in desorption of some amount of absorbed CO₂ on the CO₂ sorbent, regenerating fresh CO₂ sorbent.

The invention also provides a system for regenerating spent aqueous solvent using microwave absorbers for carbon dioxide capture applications comprising: a mixture comprising: an aqueous solution of a spent CO₂ sorbent, wherein the spent CO₂ sorbent comprises a CO₂ sorbent with CO₂ absorbed thereon; and a microwave absorber material mixed in the aqueous solution of spent CO₂ sorbent, wherein the microwave absorber material comprises an electrical insulator that is configured to be polarized by an applied electric field.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 is a flowchart for a method of regenerating spent aqueous solvent using microwave absorbers, in accordance with the features of the present invention;

FIG. 2A is a cross-sectional SEM image of coal-based graphene, in accordance with the features of the present invention;

FIG. 2B is a cross-sectional TEM image of coal-based graphene, in accordance with the features of the present invention;

FIG. 2C is a XPS result of coal-based graphene, in accordance with the features of the present invention;

FIG. 2D is an AFM image of coal-based graphene, in accordance with the features of the present invention;

FIG. 2E is a horizontal cross-section profile indicated by the horizontal line in the AFM image of coal-based graphene in FIG. 2D, in accordance with the features of the present invention;

FIG. 2F is a vertical cross-section profile indicated by the vertical line in the AFM image of coal-based graphene in FIG. 2D, in accordance with the features of the present invention;

FIG. 3A is a thermal image of coal-based graphene after 3 seconds of 2 Watts microwave irradiation, in accordance with the features of the present invention;

FIG. 3B is a thermal image of MWCNT after 3 seconds of 2 Watts microwave irradiation, in accordance with the features of the present invention;

FIG. 3C is a thermal image of graphite after 3 seconds of 2 Watts microwave irradiation, in accordance with the features of the present invention;

FIG. 3D is a thermal image of bituminous coal after 3 seconds of 2 Watts microwave irradiation, in accordance with the features of the present invention;

FIG. 3E is a thermal image of biochar after 3 seconds of 2 Watts microwave irradiation, in accordance with the features of the present invention;

FIG. 4A is a thermal image of deionized water after 50 W of microwave irradiation for 13 seconds in a sealed tube able to hold pressure up to 40 psi, in accordance with the features of the present invention;

FIG. 4B is a thermal image of 30 wt % MEA solution after 50 W of microwave irradiation for 13 seconds in a sealed tube able to hold pressure up to 40 psi, in accordance with the features of the present invention;

FIG. 4C is a thermal image of 1 wt % graphene in 30 wt % MEA solution after 50 W of microwave irradiation for 13 seconds in a sealed tube able to hold pressure up to 40 psi, in accordance with the features of the present invention;

FIG. 5 is a graph of temperature profiles of 30 wt % MEA solution and of 30 wt % MEA solutions mixed with 1 wt % of five different carbon-based materials under 15 W of microwave irradiation in a sealed tube able to hold pressure up to 40 psi, in accordance with the features of the present invention;

FIG. 6 is a simplified schematic of a system for CO₂ capture and regeneration testing, in accordance with the features of the present invention;

FIG. 7A is a graph of CO₂ desorption curves of 30 g of 30 wt % MEA with 1 wt % graphene solution with under 50 W microwave heating, in accordance with the features of the present invention;

FIG. 7B is a graph of CO₂ desorption curves of 30 g of 30 wt % MEA solution (without graphene) under 50 W microwave heating, in accordance with the features of the present invention;

FIG. 7C is a graph of CO₂ desorption curves of 30 g of 30 wt % MEA solution (without graphene) under oil-bath heating, in accordance with the features of the present invention;

FIG. 8 is plot of CO₂ desorption flux in relation to temperature for several MEA regeneration methods, in accordance with the features of the present invention;

FIG. 9 is an Arrhenius curve of graphene-MEA microwave regeneration, in accordance with the features of the present invention.

### DETAILED DESCRIPTION

The foregoing summary, as well as the following detailed description of certain embodiments of the present invention, will be better understood when read in conjunction with the appended drawings.

The following detailed description should be read with reference to the drawings in which similar elements in different drawings are numbered the same. The drawings, which are not necessarily to scale, depict illustrative embodiments and are not intended to limit the scope of the invention.

As used herein, sorbent means a material that absorbs another substance, wherein a sorbent is not limited to a particular state of matter.

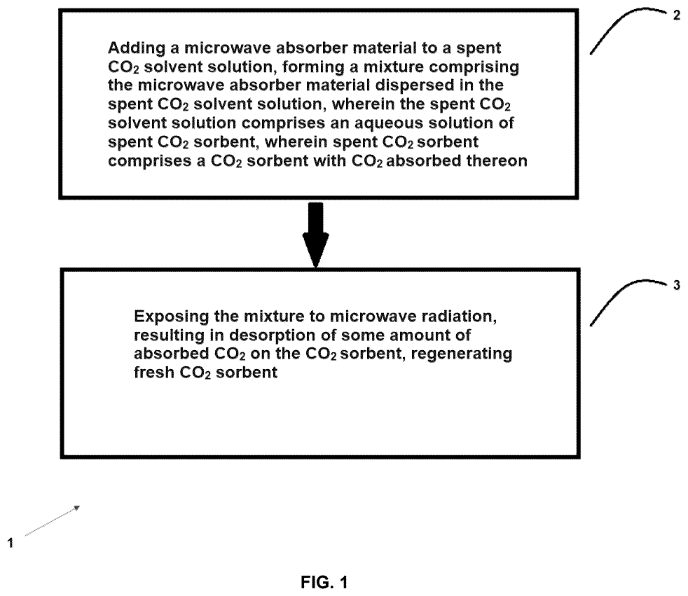

FIG. 1 depicts a flowchart for a method 1 of regenerating spent aqueous solvent using microwave absorbers for carbon dioxide capture applications. The method 1 begins by adding a microwave absorber material to a spent CO₂ solvent solution 2, forming a mixture comprising the microwave absorber material dispersed in the spent CO₂ solvent solution.

In the first step of method 1 shown in FIG. 1, a microwave absorber material is added to a spent CO₂ solvent solution 2. In an embodiment, the spent CO₂ solvent solution comprises an aqueous solution comprising a spent CO₂ sorbent, wherein the spent CO₂ sorbent comprises a CO₂ sorbent with CO₂ absorbed thereon. The CO₂ sorbent comprises any molecule or compound capable of absorbing CO₂ while said CO₂ sorbent is dissolved in an aqueous solution. Exemplary CO₂ sorbents include alkanolamines such as, but not limited to, monoethanolamine (MEA), diethanolamine (DEA), triethanolamine (TEA), methyldiethanoamine (MDEA), piperazine (PZ), 2-amino-2-methyl-1-propanol (AMP), and combinations thereof. In a further embodiment, the spent CO₂ solvent solution to which the microwave absorber material is added comprises an alkali metal hydroxide, alkali metal carbonate, and combinations thereof. Exemplary alkali metal hydroxides include, but are not limited to, potassium hydroxide and sodium hydroxide. Exemplary alkali metal carbonates include, but are not limited to, potassium carbonate and sodium carbonate.

In an embodiment, the spent CO₂ solvent solution comprises a concentration of CO₂ sorbent preferably between approximately 25 wt % and approximately 45 wt % and typically approximately 30 wt %.

A salient feature of the invention is the microwave absorber material that is added to the spent CO₂ solvent solution. The microwave absorber material described herein comprises any electrical insulator capable of being dielectrically polarized by an applied electric field. Consequently, these dielectric materials can dissipate electromagnetic waves by converting them into thermal energy through dielectric loss and magnetic loss. Exemplary microwave absorber materials include ferrite-based materials, including black iron oxide, nickel ferrite, cobalt ferrite, and Awaruite, Group IVB-VIB transition metal carbides and nitrides nanoscale carbon-based materials, including porous carbon, single walled carbon nanotubes, multi walled carbon nanotubes, carbon fibers, and graphene, and combinations thereof. Typical forms of the absorber include, but are not limited to, powders, flakes, nanotubes, nanowires, fibers, and sheets.

In an embodiment, in the adding step 2, microwave absorber material is added to the spent CO₂ solvent solution such that the resulting mixture comprises a concentration of microwave absorber in the mixture preferably between approximately 0.5 wt % and approximately 5 wt %, more preferably between approximately 1 wt % and approximately 2 wt %, and typically between approximately 1 wt % and 1.5 wt %.

In an embodiment, the concentration of the microwave absorber material in the mixture with the spent CO₂ solvent solution has negligible effect on the pumping behavior of the microwave absorber material-aqueous solvent mixture (slurry) when used in regeneration, reboiler, and stripping column infrastructure found in amine-based carbon capture processes.

Notably, in an embodiment, the microwave absorber material described herein lacks a porous micro-structure and consequently does not affect the adsorption/desorption kinetics of CO₂ after mixing with the aqueous solvent.

In an embodiment, the microwave absorber material described herein comprises graphene. In an embodiment, graphene is inexpensively synthesized from coal and coal by-products using a thermal molten salt process described in U.S. Pat. No. 11,535,518B1, the entirety of which is incorporated by reference herein. By using this method and the natural graphene like molecules contained in coal and coal by-products, the costs and technical challenges associated with making graphene are markedly reduced.

Returning to FIG. 1, the method continues with exposing the mixture, the spent CO₂ solvent solution with the microwave absorber material dispersed therein, to microwave radiation 3, resulting in release of CO₂ absorbed on the CO₂ sorbent, thereby regenerating fresh CO₂ sorbent. During the exposing step 3, the microwave absorber material absorbs microwaves and thereby increases in temperature, wherein the heated microwave absorber material is in thermal contact with and heats the spent CO₂ sorbent, resulting in the release of at least some of the CO₂ absorbed on the spent CO₂ sorbent to form a regenerated aqueous sorbent 3.

In an embodiment, the spent CO₂ sorbent has CO₂ absorbed thereon after said CO₂ solvent solution was used to scrub an effluent gas stream. A person having ordinary skill in the art will readily ascertain that said effluent gas stream can be a gas stream from any chemical or industrial process producing CO₂.

In the exposing step 3, as described above, the microwaves heat the spent CO₂ solvent solution of the spent CO₂ solvent solution and microwave absorber mixture such that some portion of CO₂ absorbed onto said spent CO₂ sorbent is released. In an embodiment, the exposing step 3 heats the spent CO₂ solvent solution to a regeneration temperature, wherein the regeneration temperature comprises the temperature wherein CO₂ absorbed onto the spent CO₂ sorbent begins to release, and wherein said regeneration temperature is the temperature of the bulk spent CO₂ solution of the spent CO₂ solvent solution and microwave absorber mixture. Preferably, said regeneration temperature is between approximately 60° C. and approximately 90° C., more preferably between approximately 75° C. and approximately 85° C., and typically between approximately 80° C. and approximately 85° C. A person having ordinary skill in the art will readily appreciate that these regeneration temperatures are exemplary and not meant to be limiting. In an embodiment, the regeneration temperature is any temperature suitable to cause release of CO₂ absorbed onto spent CO₂ sorbent.

A salient feature of the invention is that the exposing step 3 generates hot spots on the microwave absorber that is in contact with the spent CO₂ sorbent, providing sufficient heat to cause release/desorption of CO₂, without raising the bulk temperature of the CO₂ solvent solution and microwave absorber to temperatures of 100° C. or more. This is in contrast to prior art methods requiring additional time and energy to heat the bulk solution to regeneration temperatures of 100° C. or more. With this feature, in an embodiment, the invention provides lower activation energies for CO₂ release/desorption from spent CO₂ sorbent, of approximately 25 KJ/mol, and lower regeneration temperatures, of approximately 60° C. to 90° C., than prior art methods, where the bulk solution was heated to at or above 100° C., the boiling point of water. Additionally, with this feature, in an embodiment, the invention increases the energy efficiency of the CO₂ sorbent regeneration process, where desorption kinetics of microwave heating of the spent CO₂ solvent solution and microwave absorber was approximately 100 times and approximately 10 times faster than thermal heating the spent CO₂ solvent solution and microwave heating the spent CO₂ solvent solution without microwave absorber, respectively. Likewise, in some embodiments, the regeneration method can be used to reduce the amounts of make-up water required for the solvent regeneration process, as the solvent regeneration temperature, at less than approximately 100° C. (the boiling point of water), and resulting evaporative losses are reduced. In an embodiment, the invention reduces evaporative losses between approximately 30% and approximately 80% compared to prior art methods. In some embodiments, the invention reduces evaporative losses 80% where the regeneration temperature is 60° C. and 30% where the regeneration temperature is 90° C. compared to methods heating the bulk solution to 100° C. or more. Further, the regeneration method can be used to reduce corrosion to regeneration infrastructure due to reduced regeneration temperature, as temperature and corrosion rates are directly proportional in the presence of amines. Still further, the reduced regeneration temperature enabled using the instant method reduces amine loss from the CO₂ sorbent over prior art CO₂ sorbent regeneration processes.

In some embodiments, in the exposing step 3 as described above, the mixture, the spent CO₂ solvent solution containing the microwave absorber material, is exposed to microwave radiation preferably for approximately 10 minutes to approximately 60 minutes, and typically for approximately 15 minutes to approximately 20 minutes.

In some embodiments, in the exposing step 3 as described above, the microwave radiation power is approximately 15W to approximately 50W. In an alternative embodiment, the microwave radiation power is approximately 20 KW to approximately 200 kW.

In an embodiment, in the exposing step 3 as described above, CO₂ absorbed on the spent CO₂ sorbent is released and thereby regenerates fresh CO₂ sorbent, such that approximately up to 200 mL of CO₂ is released at 85° C., whereas approximately less than 1 mL of CO₂ is released was released at 85° C. using thermal heating only.

In some embodiments, the regeneration method using graphene microwave absorbers disclosed herein can be used to reduce oxidation of the amine functional groups and thus increase the service life of the solvent, as the bulk solvent is not exposed to the high temperatures reached during conventional steam regeneration.

In some embodiments, the regeneration method using graphene microwave absorbers disclosed herein can be used to accelerate bulk solvent temperature rise much more quickly than using conventional heating methods, increasing energy efficiency. Likewise, in some embodiments, the regeneration method can be used to accelerate CO₂ desorption rates compared to that of conventional heating methods, increasing energy efficiency.

In some embodiments, the graphene-amine solvent mixture is heated using microwave pulses instead of continuous microwave heating to prevent degradation of the amine solvent from graphene “hot-spots,” instantaneous high-temperature graphene particles in the mixture.

In some embodiments, the regeneration method using graphene microwave absorbers disclosed herein can be retrofitted into existing amine-based recapture processes. In an embodiment, a microwave source and waveguide can be added to an existing regeneration column or tank, allowing for the retrofitting of graphene microwave absorbers into existing amine-based recapture processes and replacing conventional steam stripping infrastructure for solvent regeneration.

### Examples

Coal-based graphene was prepared using a thermal molten salt process.

Other carbon-based materials, including powdered activated carbon (AC) was purchased from Cabot Corporation, and graphite, single-wall carbon nanotube (SWCNT), and multi-wall carbon nanotube (MWCNT), were purchased from Sigma Aldrich.

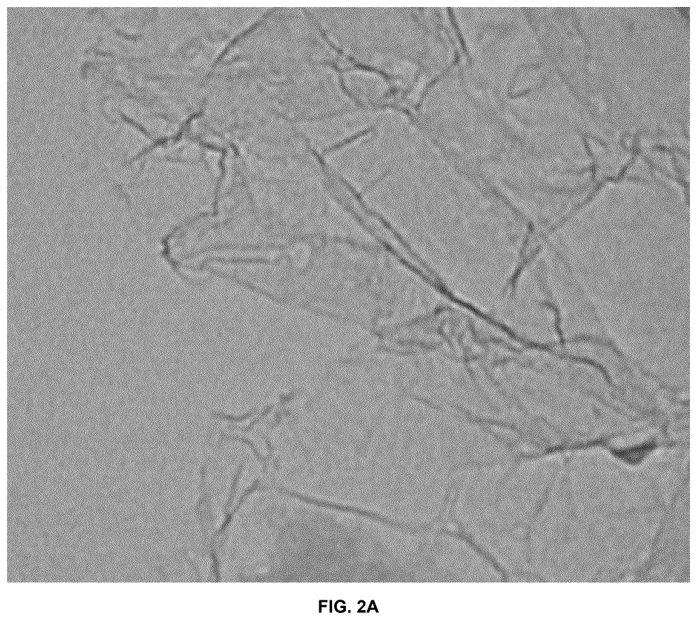

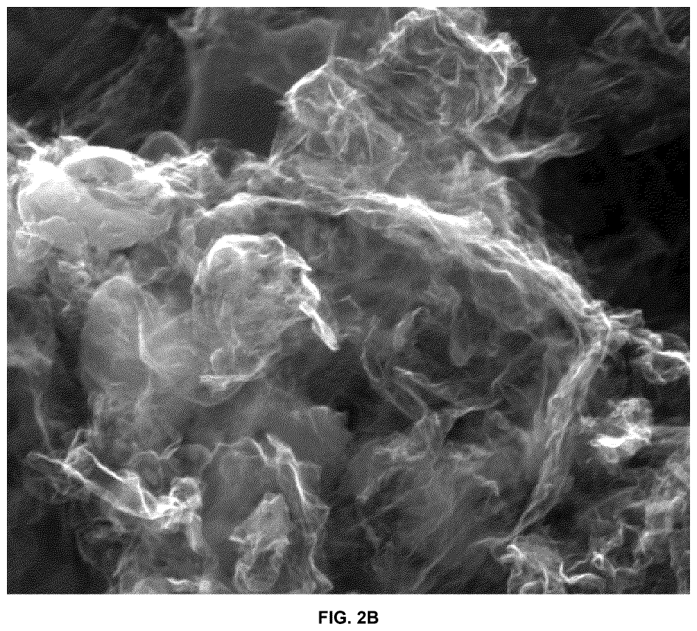

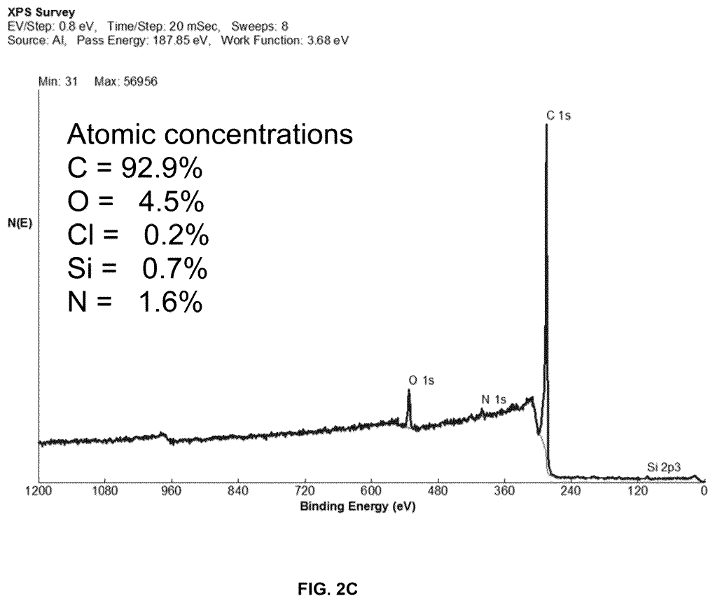

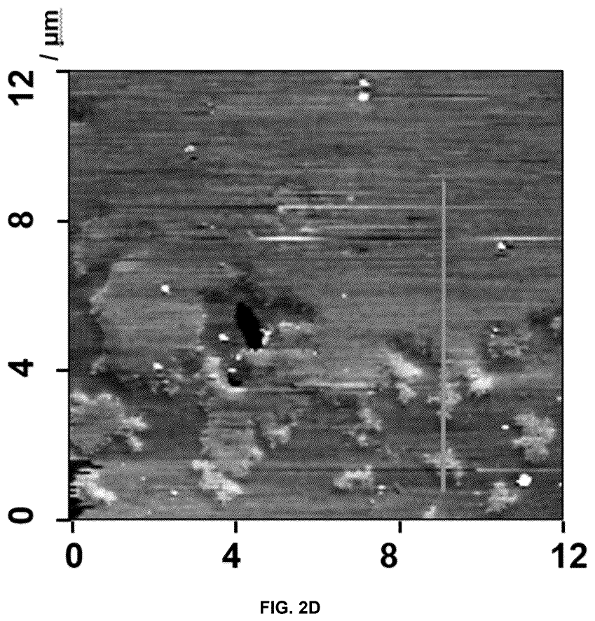

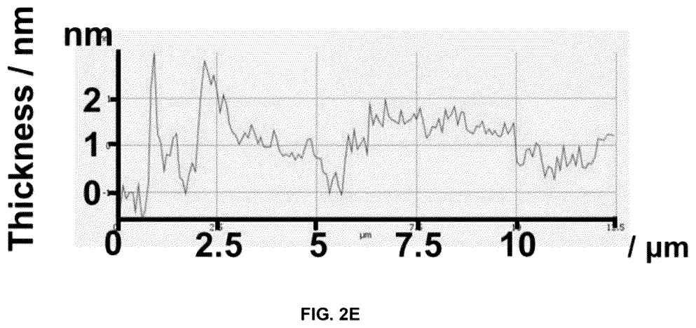

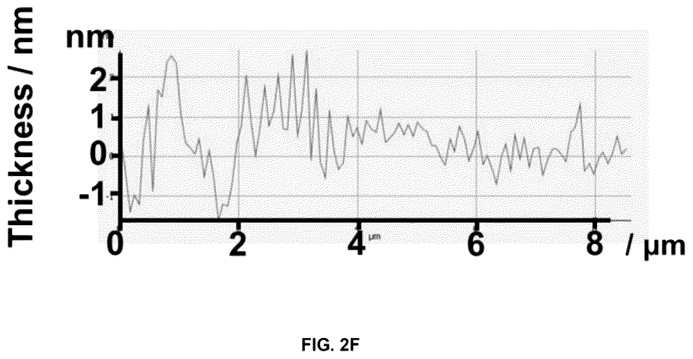

Graphene was studied to study the effect of carbon-based microwave absorber on CO₂ sorbent regeneration. The quality of coal-based graphene was assessed by scanning electron microscopy (SEM) (FIG. 2A), transmission electron microscopy (TEM) (FIG. 2B), atomic force microscopy (AFM) (FIG. 2D), and X-ray photoelectron spectroscopy (XPS) (FIG. 2C). Both SEM and TEM images of the graphene clearly showed that sheet type 2D morphology was obtained. AFM measurement revealed that the exfoliated graphene flakes had a thickness as small as 1.6 nm, as shown in FIG. 2E and FIG. 2F, indicating few layered graphene morphology was obtained. According to the elemental composition analysis by X-ray photoelectron spectroscopy (XPS), impurities, i.e., Cl and Si, were less than 1%. The major components of in-house graphene were carbon (C1s, 92.9 at %) and oxygen (01s, 4.5 at %).

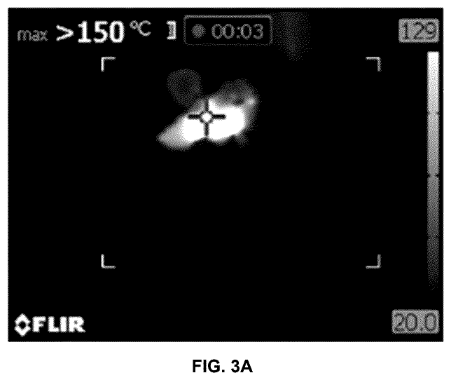

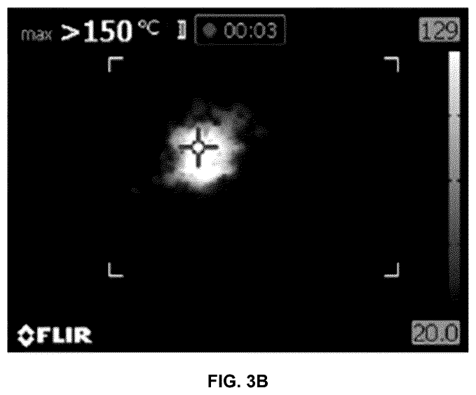

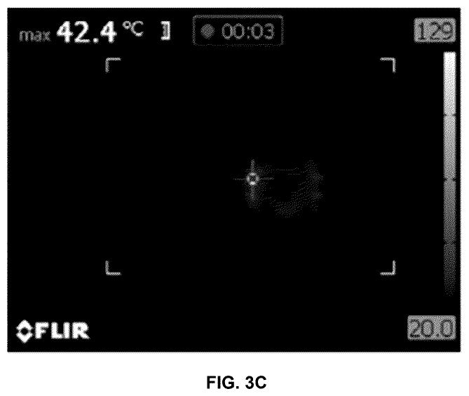

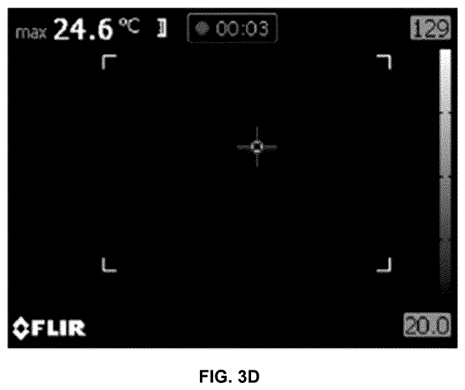

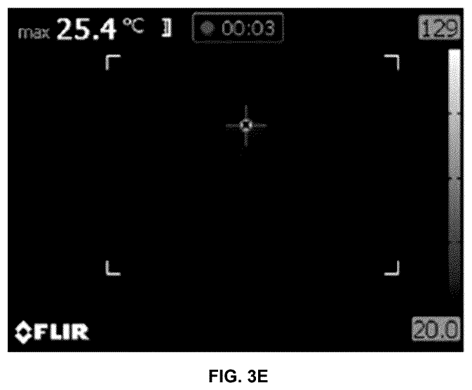

Microwave absorption tests of nanoscale carbon-based materials, including graphene and multi-walled carbon nanotubes (MWCNT) versus bulk carbon materials, including graphite, bituminous coal, and biochar, after irradiation with low power microwaves (2 W) for a short period of time (3 seconds) were performed. Both graphene (FIG. 3A) and commercial MWCNTs (FIG. 3B) exhibited similar high surface temperatures (>150° C.), indicating their strong microwave absorption capability. In contrast, graphite showed a moderate microwave absorption (FIG. 3C), while coal (FIG. 3D) and biochar (FIG. 3E) showed no obvious microwave absorption under the same low power microwave irradiation conditions.

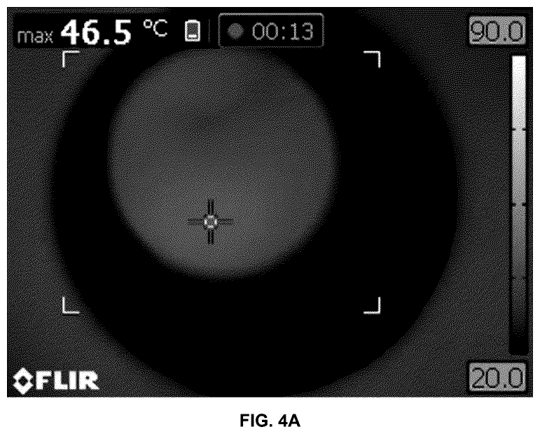

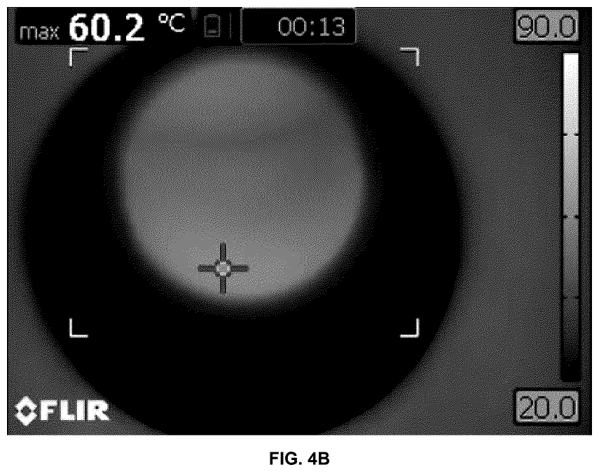

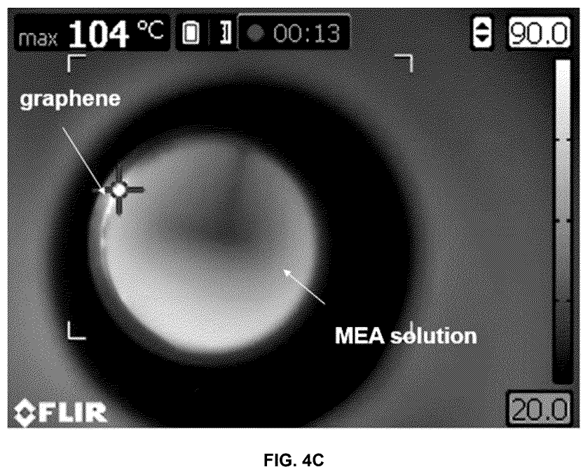

Microwave absorption tests of graphene in aqueous solutions were performed. A thermal camera was used to record the temperature profiles of aqueous solutions under microwave irradiation. Three solutions, including deionized water, an aqueous MEA (30%) solution, and an aqueous MEA (30%) solution with 1 wt % graphene, were irradiated with 50 W of microwaves for 13 seconds in sealed tubes able to hold pressure up to 40 psi. The temperature of water reached 46.5° C. (FIG. 4A), and the temperature of MEA solution reached 60.2° C. (FIG. 4B). This moderate temperature difference between the two solutions was likely due to the increased polarity by MEA. As shown in FIG. 3A, graphene exhibited strong microwave absorption and rapid temperature ramping (>150° C. over 3 seconds under 2 W). By adding 1 wt % of graphene into MEA solution (without mixing), as shown in FIG. 4C, the surface temperature of graphene reached 104° C. and bulk solution temperature was 66° C. within 13 s. During the microwave heating process, graphene was rapidly heated, and heat was concurrently dissipated to the bulk MEA solution, which resulted bulk temperature rise. Therefore, adding small amount of a microwave absorber, including graphene, can effectively absorb microwave energy and accelerate bulk solution temperature rise.

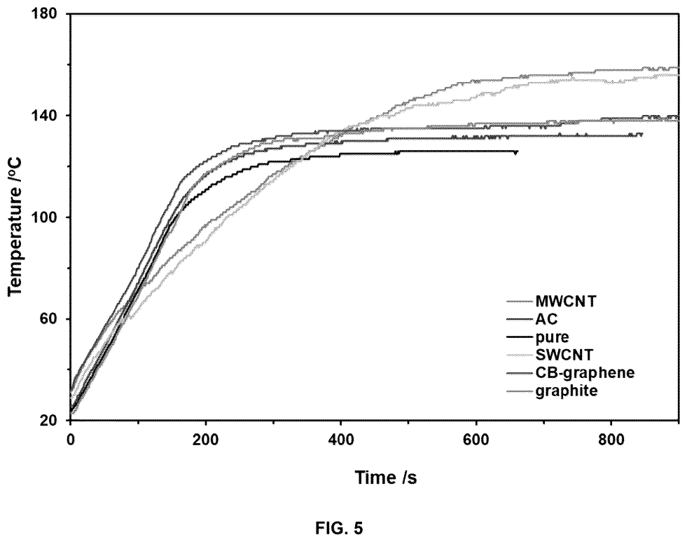

Microwave absorption tests for an aqueous 30 wt % MEA solution and MEA solutions mixed with 1 wt % of five different carbon-based materials, including powdered activated carbon, graphite, SWCNT, MWCNT, and coal-based graphene, were performed under 15 W of microwave irradiation in sealed tubes able to hold pressure up to 40 psi (FIG. 5). All said carbon-based nanoscale materials exhibited superior capability of microwave absorption than the aqueous MEA solution alone. Coal-based graphene showed similar final temperature to that of graphite. Despite the maximum temperatures of SWCNT and MWCNT solutions reached above 160° C., the ramping rate was slower than the other carbon materials. All of the carbon-based nanoscale materials show potential as effective microwave absorbers capable of accelerating aqueous MEA-based CO₂ sorbent regeneration.

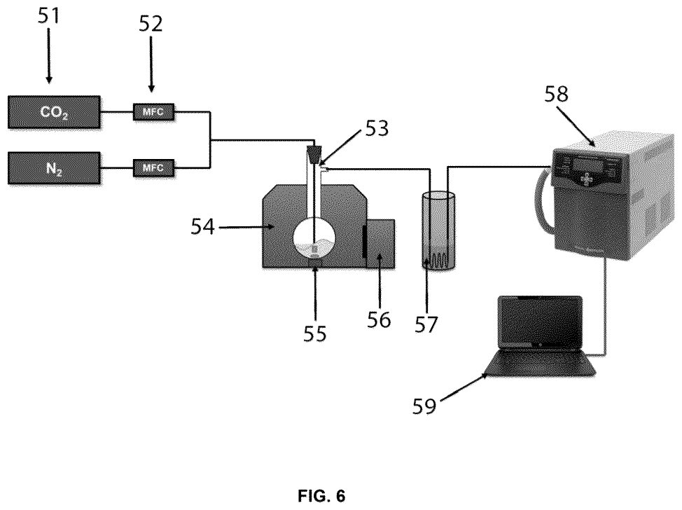

CO₂ capture and regeneration testing were performed using the system shown in FIG. 6. About 50 ml of aqueous MEA (30%) solution was added in a round-bottom flask 53 and was then exposed to 14% CO₂/N₂ (50 mL/min) 51 through mass flow controllers 52 until saturated. The composition of the tail gas was analyzed by a mass spectrometer (OmniStar GSD 320 Gas Analyzer) 58 in communication with a computer 59. Once the MEA solution was fully saturated, the flask was transferred to a microwave reactor (CEM Discover) 54 in communication with an IR temperature sensor 55 for desorption experiments. The magnetron's 56 microwave power output was controlled at 50 W, unless specified.

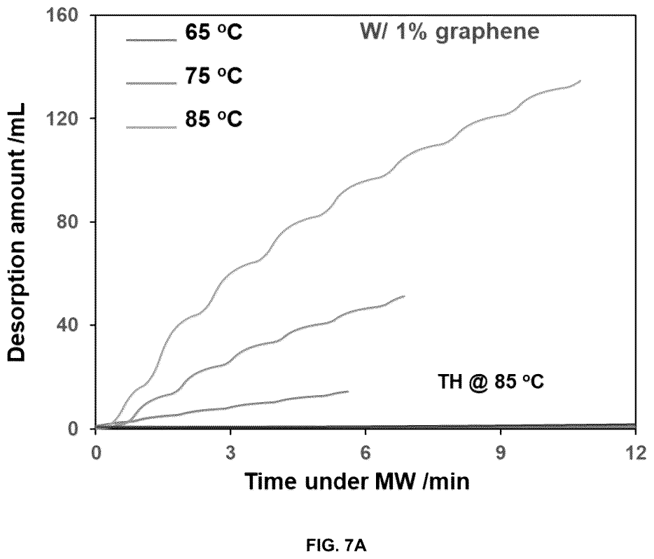

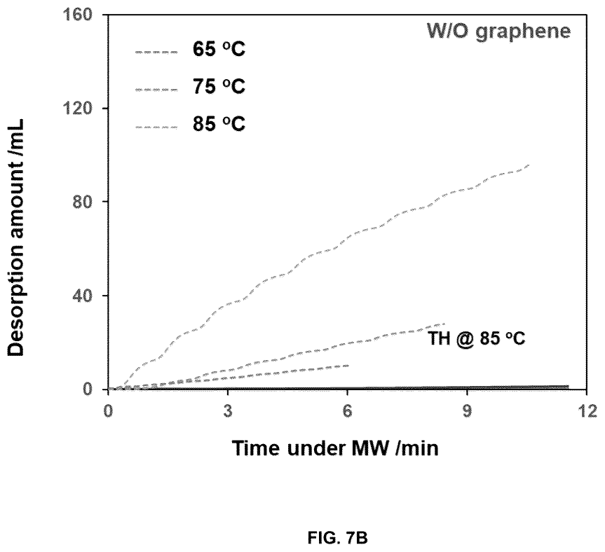

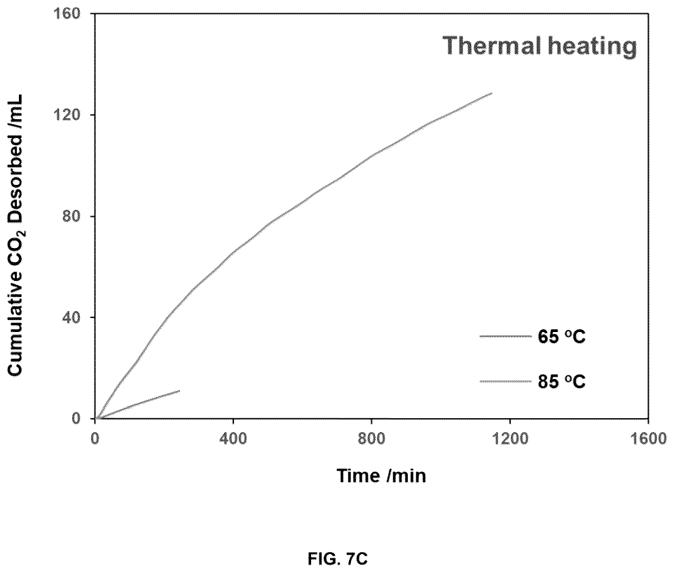

CO₂ desorption testing was performed. Only graphene was tested for CO₂ desorption experiments, because its 2D structure has negligible effects on CO₂ desorption kinetics. CO₂ desorption tests were performed for aqueous amine (MEA) solutions with and without graphene (1 wt %) at temperatures of 65° C., 75° C., and 85° C. For each test, using the system shown in FIG. 6, about 50 ml of aqueous MEA (30 wt %) solution was saturated by exposing to 14% CO₂/N₂ (50 mL/min for several hours). During the microwave desorption, the amount of CO₂ in effluent gas was sent through a cold trap 57, measured by an online mass spectrometer 58, and plotted against time elapsed irradiated under microwave radiation, as shown in FIG. 7A and FIG. 7B. For comparison, conventional thermal heating (TH) desorption tests at 65° C. and 85° C. using a hot plate with silicone oil were also measured as a baseline, as shown in FIG. 7C.

Under 50 W MW irradiation, average CO₂ desorption rates of the 30 wt % MEA solution were 1.7 mL/min, 3.6 mL/min, and 9.1 mL/min at 65° C., 75° C., and 85° C., respectively (FIG. 7A). By adding 1 wt % of graphene into solution, average CO₂ desorption rates immediately increased at least 35% up to 2.3 mL/min, 7.6 mL/min, and 12.6 mL/min at 65° C., 75° C. and 85° C., respectively (FIG. 7B). These boosted desorption rates in the presence of graphene were primary due to better microwave energy absorption and the existence of “hot-spots,” instantaneous high-temperature graphene particles in the MEA solution. In an embodiment, CO₂ desorption is promoted at the interface between the graphene particle “hot-spots” and the MEA solution without having to raise the bulk MEA temperature to the high temperatures typically required for regeneration using conventional heating. Hence, as the bulk temperature of the MEA solution does not need to be heated to high temperatures to promote CO₂ desorption, the addition of graphene microwave absorbers to the MEA solution reduces oxidation of the amine functional groups in the MEA solvent and consequently increases the stability and the service life of the MEA solvent.

In contrast, several hours were required to desorb the same amount of CO₂ by using a conventional heating (FIG. 7C). The average desorption rate at 65° C. and 85° C. was 0.064 mL/min and 0.1 mL/min, respectively, which was significantly lower than those of microwave heating. Further, in an embodiment, when microwave energy was turned off, graphene immediately cooled down without external heat exchangers. This would make the microwave temperature swing process much simpler than current steam (thermal) regeneration processes which require large reboilers and heat exchangers for cooling the solvent.

In an embodiment, based on calculations, the CO₂ desorption flux of MEA under thermal heating, microwave heating and microwave heating with graphene at 85° C. was 0.004 min⁻¹, 0.29 min⁻¹ and 0.5 min⁻¹, respectively, as shown in Table 1. Desorption flux measures the gas desorption kinetics from the same amount of solvent. In an embodiment, CO₂ desorption flux was defined as the amount of CO₂ transported per unit time across a unit volume normal to the direction of transport. Thus, the microwave desorption flux of MEA with graphene was over two orders of magnitude faster than the desorption rate of MEA using thermal heating. Stated differently, in order to release 1 mmol of CO₂ from 100 mL of MEA (30%) solution at 85° C., it would take approximately 1 hour using thermal regeneration, whereas it would take approximately only half a minute for graphene-MEA solution using microwave heating.

TABLE 1
Desorption of CO₂ using thermal heating (TH), microwave
heating (MW) with and without graphene at 85° C.

| | Time | Desorption flux * |
|---|---|---|
| | (min · mmol⁻¹) | (mL · min⁻¹ · mLₛₒₗᵥₑₙₜ⁻¹) |
| TH @85° C. | 56.3 | 0.004 |
| MW @85° C. | 0.77 | 0.29 |
| MW W/graphene @85° C. | 0.45 | 0.50 |

* 30% MEA solution Density (@85° C.) = 1.0 g/mL

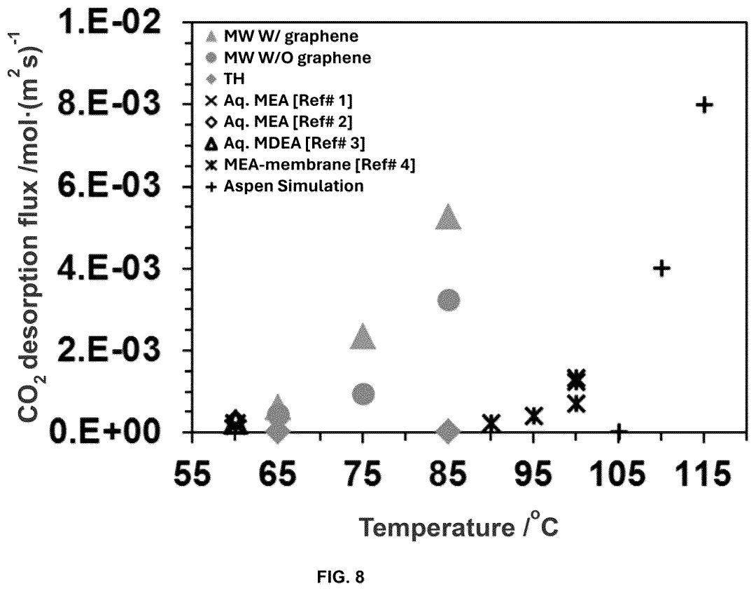

Likewise, in an embodiment, a higher CO₂ desorption flux was demonstrated for microwave heating graphene-MEA solution compared to other regeneration methods, as shown in FIG. 8.

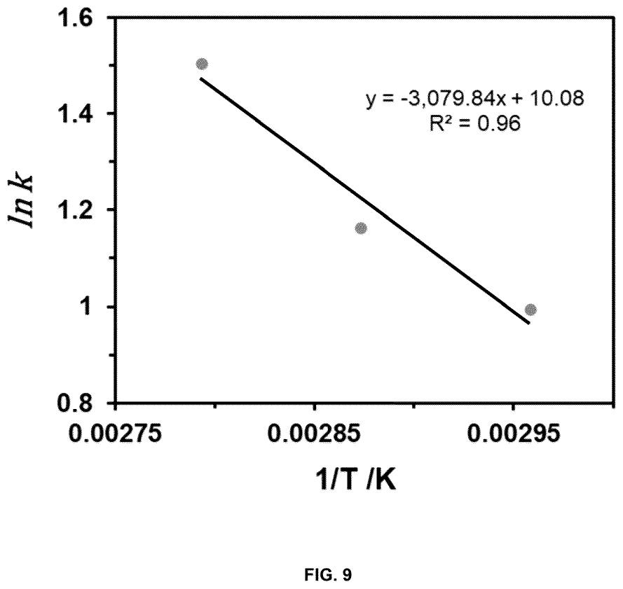

In an embodiment, as CO₂ desorption is recognized as a pseudo-first order reaction, the microwave-accelerated CO₂ desorption rate constants for a graphene-MEA solution at 65° C., 75° C., and 85° C. were calculated and are shown in Table 2. Likewise, in an embodiment, according to the Arrhenius plot of FIG. 9, the apparent activation energy of desorption of was about 25.6 KJ·mol⁻¹. This activation energy of desorption value for graphene-MEA solution is lower than previously reported values of about 35-60 KJ−mol⁻¹ for aqueous amine solutions regenerated using conventional steam heating.

TABLE 2
Reaction rate constant and activation energy of MEA/graphene
regeneration using microwave heating (MW)

| | k/s⁻¹ | | | |
|---|---|---|---|---|
| | 65° C. | 75° C. | 85° C. | Eₐ/kJ · mol⁻¹ |
| MW W/ | 0.044 | 0.053 | 0.075 | 25.6 |
| graphene | | | | |

In an embodiment, the low activation energy of desorption demonstrated above implies that CO₂ desorption can be performed at a low bulk temperature, i.e., about 85° C. using aqueous MEA solvent solution with graphene and microwave heating. There are marked advantages in performing CO₂ sorbent regeneration below the boiling point of water, i.e., 100° C., including, but not limited to, lower energy penalty for the regeneration process, lower make-up water required to replace evaporative losses, reduced duty on re-boiler and heat exchangers, reduced size of the stripping column, and lower operation costs and capital costs.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

What is claimed is:

1. A method of regenerating spent aqueous solvent using microwave absorbers for carbon dioxide capture applications comprising the steps of:
adding a microwave absorber material to a spent CO₂ solvent solution, forming a mixture comprising the microwave absorber material dispersed in the spent CO₂ solvent solution, wherein the spent CO₂ solvent solution comprises an aqueous solution of spent CO₂ sorbent, wherein spent CO₂ sorbent comprises a CO₂ sorbent with CO₂ absorbed thereon; and
exposing the mixture to microwave radiation, resulting in desorption of some amount of absorbed CO₂ on the CO₂ sorbent, regenerating fresh CO₂ sorbent.

2. The method of claim 1 wherein the spent CO₂ solvent solution comprises an aqueous solution of a CO₂ sorbent, the CO₂ sorbent comprising an alkanolamine selected from the group consisting of monoethanolamine (MEA), diethanolamine (DEA), triethanolamine (TEA), methyldiethanoamine (MDEA), 2-amino-2-methyl-1-propanol (AMP), and combinations thereof.

3. The method of claim 1 wherein the microwave absorber comprises an electrical insulator material that is dielectrically polarized by the microwave radiation in the exposing step.

4. The method of claim 3 wherein the microwave absorber material comprises a nanoscale carbon-based material.

5. The method of claim 4 wherein the nanoscale carbon-based material comprises graphene.

6. The method of claim 1 wherein the microwave absorber material comprises between about 0.5 wt % to about 5 wt % of the mixture.

7. The method of claim 2 wherein the spent CO₂ solvent solution comprises between about 25 wt % and about 45 wt % CO₂ sorbent.

8. The method of claim 1 wherein exposing the mixture to microwave radiation heats the mixture to a temperature between about 60° C. and about 90° C.

9. The method of claim 1 wherein the desorption of some amount of absorbed CO₂ from the spent CO₂ sorbent occurs at an activation energy of desorption of between about 20 KJ·mol⁻¹ and about 28 KJ·mol⁻¹.

10. A system for regenerating spent aqueous solvent using microwave absorbers for carbon dioxide capture applications comprising:
a mixture comprising:
an aqueous solution of a spent CO₂ sorbent, wherein the spent CO₂ sorbent comprises a CO₂ sorbent with CO₂ absorbed thereon; and
a microwave absorber material mixed in the aqueous solution of spent CO₂ sorbent,
wherein the microwave absorber material comprises an electrical insulator that is configured to be polarized by an applied electric field.

11. The system of claim 10 wherein the CO₂ sorbent comprises an alkanolamine selected from the group consisting of monoethanolamine (MEA), diethanolamine (DEA), triethanolamine (TEA), methyldiethanoamine (MDEA), 2-amino-2-methyl-1-propanol (AMP), and combinations thereof.

12. The system of claim 10 wherein the microwave absorber material comprises a nanoscale carbon-based material.

13. The system of claim 12 wherein the microwave absorber comprises graphene.

14. The system of claim 10 wherein the mixture comprises between about 0.5 wt % and about 5 wt % microwave absorber.

15. The system of claim 14 wherein the aqueous solution of spent CO₂ sorbent comprises between about 25 wt % and about 45 wt % CO₂ sorbent.

16. The system of claim 10 wherein the mixture is configured to desorb CO₂ from the CO₂ sorbent occurs at an activation energy of desorption of between about 20 KJ·mol⁻¹ and about 28 KJ·mol⁻¹.
